(19) United States
(12) Patent Application Publication
(10) Pub. No.: US 2021/0299659 A1
(43) Pub. Date: Sep. 30, 2021

(54) LIQUID HANDLING DEVICE AND LIQUID HANDLING METHOD

(71) Applicant: Enplas Corporation, Kawaguchi-shi (JP)

(72) Inventor: Nobuya Sunaga, Saitama (JP)

(21) Appl. No.: 17/206,461

(22) Filed: Mar. 19, 2021

(30) Foreign Application Priority Data
Mar. 25, 2020 (JP) 2020-054327

(51) Int. Cl. B01L 3/00

(52) U.S. Cl. CPC B01L 3/502715; B01L 3/50273; B01L 2200/141; B01L 2400/0481; B01L 2300/0816

(57) ABSTRACT

A liquid handling device includes a chamber including a first opening and a second opening in a wall surface; a first channel connected to the first opening of the chamber; and a second channel connected to the second opening of the chamber. The chamber includes a recess and a film disposed to cover an opening of the recess, the film including an air chamber part curved to a side opposite to the recess. In plan view, an entirety of the air chamber part is disposed inside the opening of the recess.

### CROSS REFERENCE TO RELATED APPLICATIONS

This application is entitled to (or claims) the benefit of Japanese Patent Application No. 2020-054327, filed on Mar. 25, 2020, the disclosure of which including the specification, drawings and abstract is incorporated herein by reference in its entirety.

### TECHNICAL FIELD

The present invention relates to a liquid handling device and a liquid handling method.

### BACKGROUND ART

In recent years, fluid handling devices have been used to analyze trace amounts of substances such as proteins and nucleic acids with high accuracy and speed. Fluid handling devices have the advantage of requiring only a small amount of reagents and samples for analysis, and are expected to be used in a variety of applications such as clinical tests such as genetic tests, food tests, and environmental tests (see, for example, PTL 1).

In genetic testing, polymerase chain reaction (hereinafter also referred to as “PCR”) or the like may be performed. In PCR, double-stranded DNA is denatured into single-stranded DNA. Then, a primer that binds only to a specific site of the single-stranded DNA is used to generate a double-stranded DNA corresponding to a specific region of the single-stranded DNA. Then, by repeating these steps, only the specific double-stranded DNA is amplified. In this type of PCR, it is necessary to heat the solution containing the DNA and primer when denaturing the double-stranded DNA into single-stranded DNA.

### CITATION LIST

### Patent Literature

### PTL 1

Japanese Unexamined Patent Application Publication (Translation of PCT Application) No. 2004-532395

### SUMMARY OF INVENTION

### Technical Problem

In a microfluidic device that includes a chamber and a channel connected to the chamber as described in PTL 1, the solution in the chamber may expand and flow backwards during PCR. When such backflow occurs, there is a risk of inflow of fluid into a channel that is not intended to carry fluid, and contamination of a channel. In addition, if the liquid handling device includes a plurality of chambers, contamination may occur between the plurality of chambers.

An object of the present invention is to provide a liquid handling device that can suppress contamination of liquid and a liquid handling method using the liquid handling device.

### Solution to Problem

A liquid handling device of an embodiment of the present invention includes a chamber including a first opening and a second opening in a wall surface; a first channel connected to the first opening of the chamber; and a second channel connected to the second opening of the chamber. The chamber includes: a recess including the first opening and the second opening in the wall surface, and a film disposed to cover an opening of the recess, the film including an air chamber part curved to a side opposite to the recess. In plan view, an entirety of the air chamber part is disposed inside the opening of the recess.

A liquid handling method of an embodiment of the present invention is a method using the liquid handling device, the method including: pressing the air chamber part toward the recess; introducing fluid to the chamber from the first channel with the air chamber part being pressed; and introducing air to the chamber from the second channel by releasing the pressing of the air chamber part.

### Advantageous Effects of Invention

According to the present invention, contamination between liquids can be suppressed.

### BRIEF DESCRIPTION OF DRAWINGS

FIGS. 1A and 1B are drawings illustrating a configuration of a liquid handling device according to an embodiment of the present invention;

FIG. 2 is a bottom view of a substrate; and

FIGS. 3A to 3C are drawings illustrating a liquid handling method of the embodiment of the present invention.

### DESCRIPTION OF EMBODIMENTS

A liquid handling device and a liquid handling method according to an embodiment of the present invention are elaborated below with reference to the accompanying drawings.

### Configuration of Liquid Handling Device

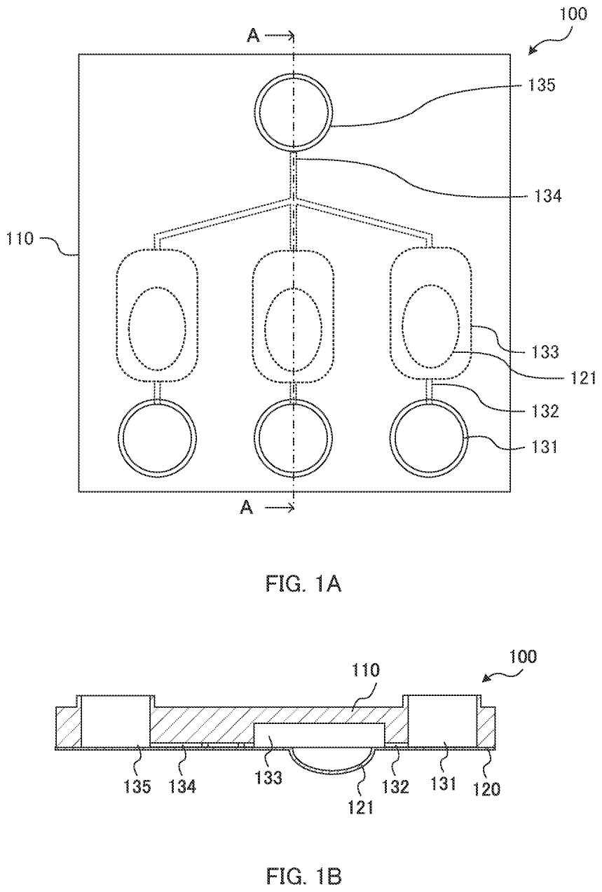

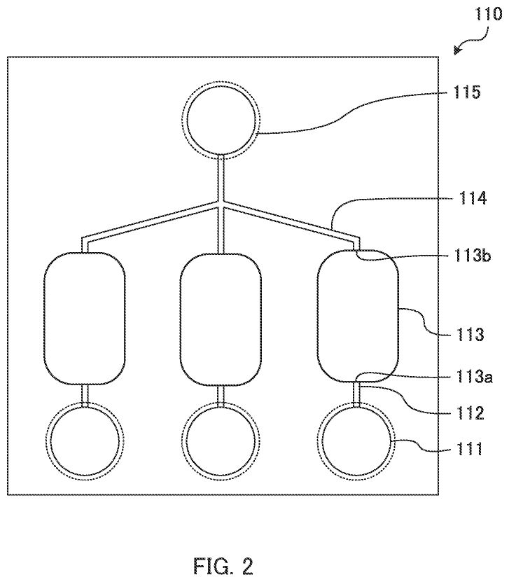

FIGS. 1A and 1B illustrate a configuration of liquid handling device 100 according to the embodiment of the present invention. FIG. 1A is a plan view of liquid handling device 100, and FIG. 1B is a sectional view taken along line A-A of FIG. 1A. FIG. 2 is a bottom view of substrate 110.

Liquid handling device 100 includes substrate 110 and film 120. Film 120 is joined on one surface of substrate 110. The region surrounded by film 120 and substrate 110 serves as a channel for carrying fluid. Liquid handling device 100 includes a plurality of liquid introduction parts 131, a plurality of first channels 132, a plurality of first chambers 133, second channel 134, and liquid sheet ejection part 135.

The liquid introduced to liquid handling device 100 is not limited as long as the liquid has fluidity, and examples of the liquid include a solution of solids dispersed or dissolved in a solvent and a liquid containing cells, proteins, or nucleic acids.

Substrate 110 is a substantially rectangular transparent plate. The thickness of substrate 110 is, but not limited to, 1 to 10 mm, for example. The material of substrate 110 is not limited, and may be appropriately selected from publicly known resins and glass. Preferably, the resin that makes up substrate 110 is a resin that can withstand heating and cooling during PCR with a small thermal expansion and a small thermal shrinkage. Examples of such a resin include resin materials such as: polyester such as polyethylene terephthalate; polycarbonate; acrylic resin such as polymethylmethacrylate; polyvinyl chloride; polyolefin such as polyethylene, polypropylene and cycloolefin resin; polyether; polystyrene; silicone resin; and various elastomers. Note that substrate 110 may be formed by injection molding and the like, for example.

As illustrated in FIG. 2, a plurality of grooves and a plurality of through holes are formed in substrate 110. Substrate 110 includes a plurality of first through holes 111, a plurality of first channels grooves 112, a plurality of first recesses 113, second channel groove 114 and second through hole 115. Film 120 is joined on the surface at which first channels grooves 112, first recesses 113 and second channel groove 114 open. When film 120 is joined to substrate 110, first through holes 111 serve as respective liquid introduction parts 131, first channels grooves 112 serve as respective first channels 132, first recesses 113 serve as respective first chambers 133, second channel groove 114 serves as second channel 134, and second through hole 115 serves as liquid sheet ejection part 135.

Film 120 is a substantially rectangular transparent resin film. Examples of the material of film 120 include polyethylene terephthalate, polycarbonate, polymethylmethacrylate, chloride vinyl, polypropylene, polyether, polyethylene, cycloolefin polymer and cycloolefin copolymer. Film 120 is joined to substrate 110 by thermo compression bonding, laser welding, an adhesive agent and the like, for example. The thickness of film 120 is, for example, 30 μm to 300 μm. In addition, the material of film 120 is not limited. The material of film 120 may be appropriately selected from publicly known resins.

Film 120 closes the openings of first channels grooves 112, first recesses 113 and second channel groove 114, and closes the one opening of each of second through hole 115 and first through holes 111.

Film 120 includes air chamber part 121. Air chamber part 121 functions to prevent contamination between liquids used. Air chamber part 121 is a part of first chamber 133. Air chamber part 121 is curved to protrude to the side opposite to first recess 113 when film 120 is joined to substrate 110. The shape of air chamber part 121 in plan view is not limited. The shape of air chamber part 121 in plan view may be a circular shape or a rectangular shape. In the present embodiment, the shape of air chamber part 121 in plan view is an elliptical shape.

In plan view, the entirety of air chamber part 121 is disposed inside the opening of first recess 113. Specifically, the outer edge of air chamber part 121 is located inside the opening of first recess 113. The position of air chamber part 121 in the opening of first recess 113 is not limited. Air chamber part 121 may be disposed on the first opening 113a side or on the second opening 113b side, or, at the center of the opening. In the present embodiment, air chamber part 121 is disposed on the first opening 113a side relative to the center of the opening.

Liquid introduction part 131 is a bottomed recess that is connected to the upstream end of first channel 132 and exposed to the outside. Liquid introduction part 131 is composed of first through hole 111 formed in substrate 110 and film 120 that closes one opening of first through hole 111. The shape and the size of liquid introduction part 131 are not limited, and may be appropriately designed as necessary. In the present embodiment, the shape of liquid introduction part 131 is a substantially columnar shape. In addition, liquid introduction part 131 may have a structure for connecting a tube, a syringe and the like, for example. The number of liquid introduction parts 131 is appropriately set in accordance with the type of the liquid used. In the present embodiment, liquid handling device 100 includes three liquid introduction parts 131. Three liquid introduction parts 131 may have the same size or different sizes. In the present embodiment, three liquid introduction parts 131 have the same size.

First channel 132 is a channel that connects liquid introduction part 131 and first chamber 133. The upstream end of first channel 132 is connected to liquid introduction part 131, and the downstream end of first channel 132 is connected to first chamber 133. First channel 132 is composed of first channel groove 112 formed in substrate 110, and film 120 that closes first channel groove 112. The structure of first channel 132 is not limited as long as the liquid inside liquid introduction part 131 can appropriately flow to first chamber 133. The cross-sectional shape of first channel 132 is not limited, and may be a semicircular shape, a rectangular shape, or a circular shape. The size of the cross section of first channel 132 is not limited. The “cross section of a channel” means a cross section orthogonal to the flow direction of the channel. The number of first channels 132 is the same as the number of liquid introduction parts 131. In the present embodiment, three first channels 132 are provided.

First chamber 133 is a region for storing liquid introduced from liquid introduction part 131, heating fluid in the region, and performing observation as necessary. First chamber 133 is connected to the downstream end of first channel 132. First chamber 133 is composed of first recess 113 formed in substrate 110 and film 120 including air chamber part 121 that closes first recess 113. First chamber 133 includes first opening 113a to which first channel 132 is connected, and second opening 113b to which second channel 134 is connected. The size and the shape of first chamber 133 in plan view are not limited as long as air chamber part 121 can be accommodated inside. The number of first chambers 133 is the same as the number of first channels 132. Specifically, in the present embodiment, three first chambers 133 are provided.

While the ratio of the capacity of first recess 113 and the capacity of air chamber part 121 is not limited, the ratio is calculated in consideration of bumping in which liquid at a temperature near the boiling point forms bubbles with external or internal stimulus, or volume expansion due to expansion of dissolved air in the liquid. Preferably, the ratio of the internal capacity of first recess 113 and the internal capacity of air chamber part 121 is, for example, approximately 1:9 to 4:6. If the capacity of air chamber part 121 is extremely small relative to the capacity of first recess 113, contamination between liquids may occur when liquid bumping occurs. If the capacity of air chamber part 121 is larger than the capacity of first recess 113, the amount of liquid inside first recess 113 is small, which makes it difficult to heat or observe the fluid. Here, “the capacity of first recess 113” means the capacity of the region surrounded by first recess 113 and film 120 in the case where first recess 113 and film 120 closing it are flat. In addition, “the capacity of air chamber part 121” means the capacity of the region surrounded by a flat film and film 20 including air chamber part 121.

Second channel 134 is a channel that connects first chamber 133 and liquid sheet ejection part 135. The upstream end of second channel 134 is connected to first chambers 133, and the downstream end of second channel 134 is connected to liquid sheet ejection part 135. Second channel 134 is composed of second channel groove 114 formed in substrate 110 and film 120 that closes second channel groove 114. The structure of second channel 134 is not limited as long as the liquid inside first chamber 133 can appropriately flow to liquid sheet ejection part 135. The cross-sectional shape of second channel 134 is not limited, and may be a semicircular shape, a rectangular shape, or a circular shape. The size of the cross section of second channel 134 is not limited. The upstream end of second channel 134 branches out in the same number as the number of first chambers 133. That is, in the present embodiment, the upstream end of second channel 134 branches into three.

Liquid sheet ejection part 135 is a bottomed recess connected to the downstream end of second channel 134 and exposed to the outside. Liquid sheet ejection part 135 is composed of second through hole 115 formed in substrate 110 and film 120 that closes one opening of second through hole 115. The shape and the size of liquid sheet ejection part 135 are not limited, and may be appropriately designed as necessary. In the present embodiment, the shape of liquid sheet ejection part 135 is a substantially columnar shape. In addition, liquid sheet ejection part 135 may include a structure for connecting a tube, a syringe and the like, for example.

### Liquid Handling Method

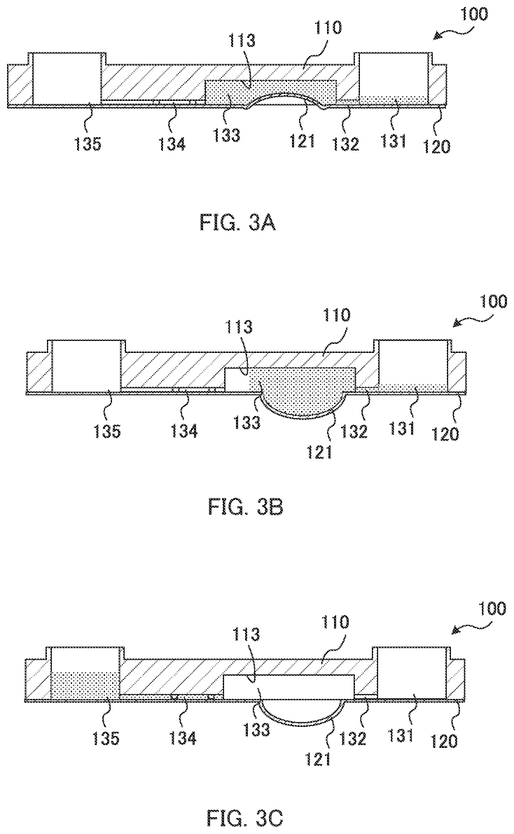

Next, a liquid handling method using the above-described liquid handling device 100 is described. FIGS. 3A to 3C are drawings illustrating a liquid handling method using liquid handling device 100.

The liquid handling method using liquid handling device 100 includes a step of pressing air chamber part 121 toward first recess 113, a step of introducing fluid to first chamber 133 from first channel 132 with air chamber part 121 being pressed, and a step of releasing the pressing of air chamber part 121 to introduce air to first chamber 133 from second channel 134. Each step is elaborated below.

As illustrated in FIG. 3A, first, fluid is introduced to first chamber 133 from first channel 132 with air chamber part 121 being pressed toward first recess 113. While the capacity for pressing air chamber part 121 toward first recess 113 is not limited, it is preferable to press it such that the capacity is as large as possible, from a view point of preventing contamination. The method of moving the liquid from liquid introduction part 131 to first chamber 133 is not limited. The inside of liquid introduction part 131 may be set to a pressing state, or liquid sheet ejection part 135 may be set to a negative pressure state. With such configurations, the liquid inside liquid introduction part 131 is introduced to first chamber 133 through first channel 132.

Next, as illustrated in FIG. 3B, air is introduced to first chamber 133 from second channel 134. To be more specific, air is introduced to first chamber 133 from second channel 134 by releasing the pressing of air chamber part 121. It is preferable that liquid introduction part 131 be being closed at this time. In this manner, the air enters first chamber 133 from the released liquid sheet ejection part 135 side.

Next, in first chamber 133, the fluid is heated and observed as necessary. At this time, the air is present in the region on the downstream side of first chamber 133, and therefore even when bumping of the liquid inside first chamber 133 occurs, the liquid inside adjacent first chamber 133 does not flow back to the inside of first chamber 133.

Next, as illustrated in FIG. 3C, the liquid inside first chamber 133 is sent to liquid sheet ejection part 135. The method of moving the liquid from first chamber 133 to liquid sheet ejection part 135 is not limited. The inside of liquid introduction part 131 may be set to a pressed state, or liquid sheet ejection part 135 may be set to a negative pressure state. In this manner, the liquid inside first chamber 133 is introduced to liquid sheet ejection part 135 through second channel 134.

### Effect

As described above, according to the present invention, air is present in the region on the downstream side of first chamber 133, and thus contamination between liquids can be suppressed.

### INDUSTRIAL APPLICABILITY

The liquid handling device and the liquid handling method of the embodiment of the present invention are applicable to laboratory tests, food tests, environment tests and the like, for example.

### REFERENCE SIGNS LIST

100 Liquid handling device
110 Substrate
111 First through hole
112 First channel groove
113 First recess
114 Second channel groove
115 Second through hole
120 Film
121 Air chamber part
131 Liquid introduction part
132 First channel
133 First chamber
134 Second channel
135 Liquid sheet ejection part

What is claimed is:

1. A liquid handling device comprising:
a chamber including a first opening and a second opening in a wall surface;
a first channel connected to the first opening of the chamber; and
a second channel connected to the second opening of the chamber,
wherein the chamber includes:
a recess including the first opening and the second opening in the wall surface, and
a film disposed to cover an opening of the recess, the film including an air chamber part curved to a side opposite to the recess, and
wherein in plan view, an entirety of the air chamber part is disposed inside the opening of the recess.

2. The liquid handling device according to claim 1, wherein a ratio of a capacity of the recess and a capacity of the air chamber part is 1:9 to 4:6.

3. A liquid handling method using the liquid handling device according to claim 1, the method comprising:
pressing the air chamber part toward the recess;
introducing fluid to the chamber from the first channel with the air chamber part being pressed; and
introducing air to the chamber from the second channel by releasing the pressing of the air chamber part.

4. A liquid handling method using the liquid handling device according to claim 2, the method comprising:
pressing the air chamber part toward the recess;
introducing fluid to the chamber from the first channel with the air chamber part being pressed; and
introducing air to the chamber from the second channel by releasing the pressing of the air chamber part.
